(19) United States
(12) Patent Application Publication
(10) Pub. No.: US 2006/0223568 A1
(43) Pub. Date: Oct. 5, 2006

(54) System and method for initiating and conducting polite communications

(76) Inventors: John M. Harris, Chicago, IL (US); Ronald T. Crocker, St. Charles, IL (US)

Correspondence Address: MOTOROLA, INC., 1303 EAST ALGONQUIN ROAD, IL01/3RD, SCHAUMBURG, IL, 60196, US

(21) Appl. No.: 11/093,486

(22) Filed: Mar. 30, 2005

(51) Int. Cl. H04M 1/00

(52) U.S. Cl. 455/550.1; 455/445

(57) ABSTRACT

A target mobile station (104) is operated in an automatic answer mode. At least one session invitation (106) is received at the target mobile station (104). The session invitation (106) requests that a user manually accept the session invitation (106) thereby, at least temporarily, overriding the automatic answer mode. A determination is made as to whether to manually accept the at least one session invitation (106).

### FIELD OF THE INVENTION

The field of the invention relates to routing communications through networks and, more specifically, to providing for polite communications within these networks.

### BACKGROUND OF THE INVENTION

Various types of communication services such as push-to-talk (PTT) and push-to-image provide fast and reliable ways for an originating user to rapidly and conveniently send a message and/or other media to a target user. For instance, in PTT systems, a user at an originating mobile station communicates with a user at a target mobile station by pushing a PTT button to establish a communication channel and send an audio message to the user at the target mobile station.

Mobile stations typically operate in a variety of states or modes. For example, many mobile stations operate in an automatic answer state whereby calls received are automatically processed according to predetermined call processing policies. In another example, mobile stations sometimes operate in a manual answer state where the user must manually determine how to handle each incoming call.

Known PTT systems sometimes provide a polite communication feature so that a user at a target mobile station is not interrupted by an unwanted message sent by a user at the originating mobile station. In these known systems, an alert message must first be sent from the originating mobile station to the target mobile station and the originating mobile station waits for the approval of the user at the target mobile station before an audio message is sent to the target mobile station.

While providing for the polite receipt of messages in PTT systems, these current approaches have significant limitations. For instance, a substantial amount of delay is introduced into the system as both alert and response messages have to traverse between the originating mobile station and the target mobile station. User interaction with the mobile stations is also increased, requiring both the originator and the target to touch the mobile unit multiple times during a call. Moreover, the current approaches are not viable for group calls, since the amount of messaging and overhead associated with sending multiple messages between multiple users is significantly increased. Another significant drawback of current approaches is that a mobile station must operate either in a fully automatic answer mode, where the user has no control over whether to accept a call, or a completely manual answer mode where, for every call, the user must determine manually whether to accept the call. This inflexibility increases user frustration and degrades the user experience with the system.

### BRIEF DESCRIPTION OF THE DRAWINGS

FIG. 1 is block diagram of a system for exchanging polite communications according to the present invention;

FIG. 2 is a block diagram of a mobile station that facilitates exchanging of polite communications according to the present invention;

FIG. 3 is a state transition diagram showing the state transitions occurring at a mobile station according to the present invention;

FIG. 4 is a call flow diagram of the message flow in a system for exchanging polite communications according to the present invention;

FIG. 5 is a call flow diagram of another message flow in a system for exchanging polite communications according to the present invention;

FIG. 6 is a call flow diagram of still another message flow in a system for exchanging polite communications according to the present invention; and

FIG. 7 is a flow chart of an approach for processing a session invitation message according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method politely initiates and conducts communications between originating and target mobile stations by sending a session invitation to the target mobile station, which is currently operating in an automatic answer mode of operation. When the session invitation is manually accepted by the user at the target, the state of the target mobile station is temporarily changed to a manual answer mode. The approaches described herein reduce delay times in the system, reduce the number of user interactions required, and are conducive to making group calls. At the same time, fast communications between users are also maintained.

In many of these embodiments, a target mobile station is operated in an automatic answer mode. At least one session invitation is received at the target mobile station. The session invitation requests that a user at the target mobile station manually accept the session invitation thereby, at least temporarily, overriding the automatic answer mode. A determination is made by the user at the target mobile station as to whether to manually accept the session invitation. The session invitation may be in any number of formats such as a polite invite message, or an automatic answer override message. Other examples of session invitations are possible.

In others of these embodiments, media is received along with the session invitation. In one example, the received media comprises an audio message. In other examples, the received media may be images, data, or combinations of images, audio, and data. In some examples, the media may only be rendered at the target mobile station when a user manually accepts the session invitation.

Various messages may be exchanged between the originating and target mobile stations. For instance, in some of these embodiments, an alert message is sent to the originating mobile station when the target mobile station completes rendering the media delivered with the session invitation. In still other examples, the originating user is informed that the target mobile station does not accept the session invitation.

Different options may also be used to render the media received at the target mobile station. In one example, when the determining results in the user at the target mobile station manually accepting the session invitation, the media is rendered to the user substantially immediately after the user at the target mobile station accepts. In another example, when the determining results in the user at the target mobile station not manually accepting the session invitation, the media is stored in a memory for potential later use. In still another example, when the determining results in the user at the target mobile station not manually accepting the session invitation, the media is discarded.

As mentioned above, if the user at the target mobile station determines to manually accept the at least one session invitation, the media may be rendered substantially immediately to the user. This determination may not be automatic upon acceptance and may be further based on various conditions. For example, the determination may be based on whether the target mobile station is using a speaker phone, whether the target mobile station is using a headset, the current state of the target mobile station, or whether the target mobile station is positioned in playback venue having more than a predetermined percentage of mobile stations or calls using a speaker phone. Other examples of conditions are possible.

The media sent from the originating mobile station to the target mobile station may have its quality adjusted in some of these embodiments. For example, the media sent to the target mobile station may be sent with a lower Quality of Service (QoS) until the session invitation is manually accepted. In another example, the media sent to the target mobile station may be sent with a higher QoS after the session invitation is manually accepted.

Thus, polite communications are exchanged between users in a quick and efficient manner. The approaches described herein significantly reduce system delays, significantly reduce the number of user interactions with equipment as compared to other prior art suggestions, and are conducive to making group calls. Moreover, the present approaches maintain the speedy communications provided in many current communication networks such as PTT systems.

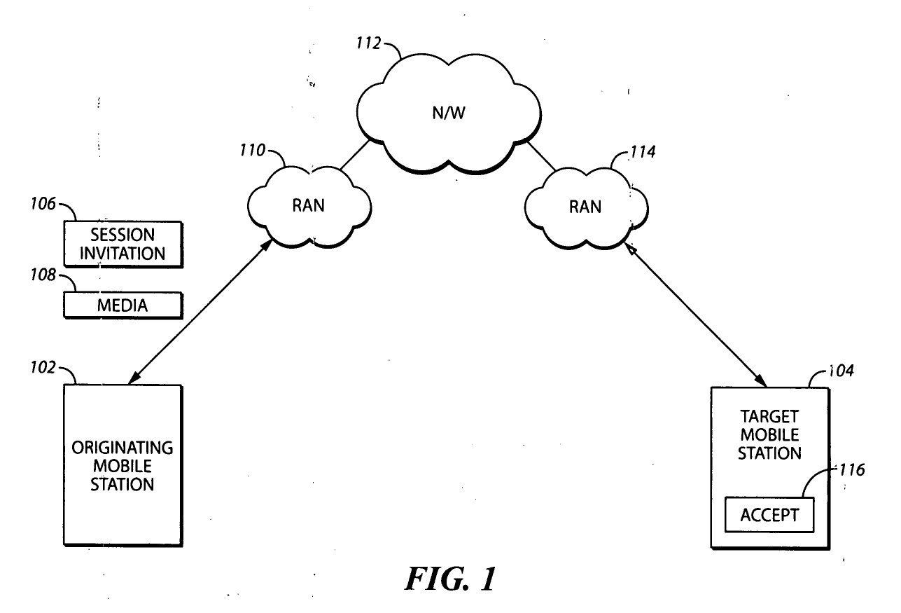

Referring now to FIG. 1, one example of a system for exchanging polite communications between mobile stations is described. An originating mobile station 102 transmits a session invitation 106 to a user at a target mobile station 104. The session invitation 106 may be sent to the target mobile station 104 via a first radio access network (RAN) 110, a network 112, and a second RAN 114.

The mobile stations 102 and 104 may be any type of portable wireless device. For instance, they may be cellular telephones, pagers, personal digital assistants, or laptop computers. Other examples of mobile stations are possible. In addition, although the examples described herein are in terms of calls between two mobile stations, it will be understood that these approaches can also be applied to group calls between more than two mobile stations.

The mobile stations 102 and 104 may operate in one or more operating modes or states. For instance, the mobile stations 102 and 104 may operate in a manual mode of operation wherein a user manually handles each and every call. In addition, the mobile stations 102 and 104 may operate in an automatic mode of operation where the handling of calls is automatically determined and based on a policy stored at the mobile station. Further, as described elsewhere in this specification, the mobile stations 102 and 104 may operate in a temporary manual answer mode that temporarily overrides the automatic answer mode. In this temporary manual answer mode, for the duration of a call, the user manually determines whether to accept communications from an originating mobile station.

The session invitation 106 is any type of communication that requests that a user manually accept the session invitation thereby, at least temporarily, overriding the automatic answer mode. The session invitation 106 may be, in one example, a polite invite message or, in another example, an override message. If the session invitation is a polite invite message, the message may include a modifier that indicates that the user at the originating mobile station is requesting that a user at the target mobile station manually accept the polite invite message.

The RANs 110 and 114 provide the functionality needed for the mobile stations 102 and 104 to communicate with each other via the network 112. In this regard, the RANs 110 and 114 may include base stations, base station controllers, servers, gateways, and/or other equipment. The network 112 may be any single network or combination of networks that allow communications to occur. The network 112 may be a wired or wireless network and may be, for instance, an extranet such as the Internet, a wireless local area network (WLAN), a cellular network, or some combination of these or other networks.

In one example of the operation of the system of FIG. 1, the mobile station 104 is operated in an automatic answer mode. A first user (“Alice”) at the originating mobile station 102 may open a contact list to see that a second user (“Bob”) at the target station is online, indicate that she wishes to politely call Bob, and press a PTT button at the originating mobile station, thereby forming the session invitation 106. Alice may also receive an indication (e.g., a confirmation tone) allowing her to record media 108 (e.g., a voice message) to send to Bob. After receiving the tone, Alice may record the media 108.

The session invitation 106 and media 108 are transmitted by the originating mobile station 102 and are received at the target mobile station 104. The session invitation 106 requests that Bob manually accept the session invitation 106 and thereby, at least temporarily, override the automatic answer mode in which the target mobile station 104 is currently operating. An alert tone is played for Bob indicating a session invitation has been received from Alice. At this point, a determination may be made by Bob as to whether to manually accept the session invitation 106, for instance, by pushing a PTT button 116.

As mentioned, media 108 may also be sent with the session invitation 106 from the mobile station 102 to the mobile station 104. In one example, the media 108 comprises an audio message. In other examples the received media 108 may be images, data, or combinations of images, audio, and data.

Once the media 108 is received at the mobile station 104 and Bob accepts the session invitation 106, different options may be used to render the media 108. In one example, if Bob manually accepts the session invitation 106, the media 108 is rendered substantially immediately to Bob. Additionally, the media may be played to Bob after a predetermined delay (e.g., five seconds). In another example, if Bob rejects the session invitation 106, the media 108 may be stored in a memory for potential later use and, in still another example, may be discarded.

If Bob accepts the session invitation 106, the determination as to whether to render the media 108 substantially immediately to Bob may not be automatic and may be further based upon a number of conditions. For example, the determination may be based upon whether the target mobile station 104 is using a speaker phone, whether the target mobile station 104 is using a headset, the current present state of the target mobile station, or whether the target mobile station 104 is positioned in playback venue where more than a predetermined percentage of calls are using a speaker phone. Other examples of conditions are possible.

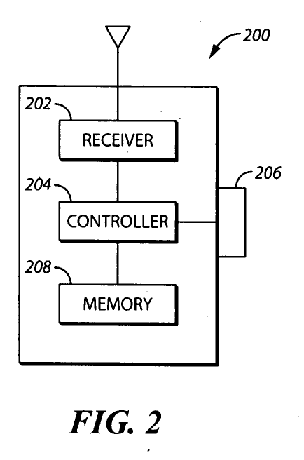

Referring now to FIG. 2, one example of a mobile station that facilitates the exchange of polite communications is described. The mobile station 200 includes a receiver 202, controller 204, memory 208, and input apparatus 206.

The controller 204 is coupled to the receiver 202 and the input apparatus 206. The controller 204 is programmed to receive a session invitation at the input of the receiver 202. As mentioned previously, the session invitation requests that a user at the mobile station 200 manually accept the session invitation thereby, at least temporarily, overriding the automatic answer mode of the mobile station 200. The controller 204 is further programmed to determine whether to accept the session invitation based at least in part upon user input received at the input apparatus 206. For instance, if the input apparatus 206 is an accept or PTT button, the pressing of the button signals the controller 204 that the user has accepted the session invitation.

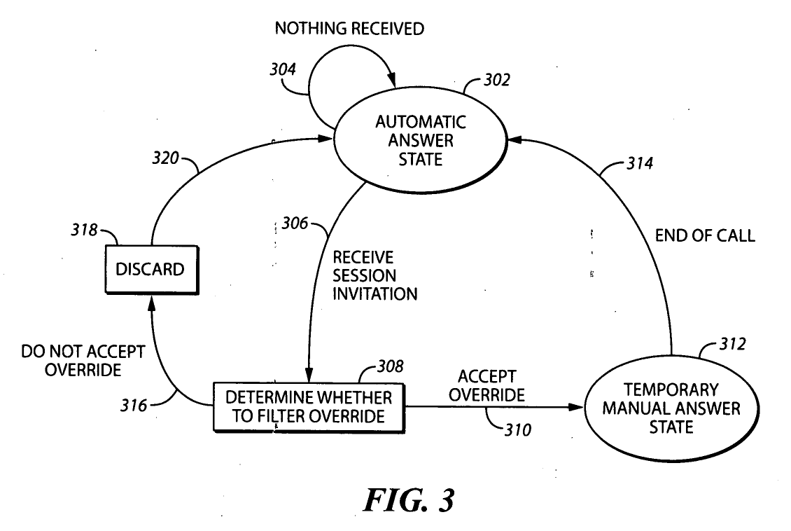

Referring now to FIG. 3, one example of a state transition diagram for a mobile station is described. The mobile station is initially in automatic answer mode 302. In this mode of operation, received calls are handled automatically according to a predetermined policy stored at the mobile station. If no session invitation arrives at step 304, the mobile station continues to operate in the automatic answer mode state 302. When a session invitation is received at step 306, execution continues at step 308 where a determination is received from a user as to whether to filter any attempt to override the automatic answer state. For example, the target mobile may not be compatible or may not support the functionality of automatic answer override.

If an accept 310 is indicated by the user, then the mobile station enters a temporary manual answer state at step 312. In this state 312, various media may be received and processed and/or the user may determine how to process the media. In one example, the media is an audio message from a user at an originating mobile station and a determination may be made to play the audio message substantially immediately. At the end of the call 314, the mobile station exits the temporary manual answer state 312 and returns to the automatic answer state 302

If a non-acceptance 316 of the session invitation is made, then at step 318, the mobile station automatically discards the message. In other examples, the message may be stored or a determination may also be made to adjust the volume of the call if a speakerphone is being used. Other actions are possible. After the action is taken, the mobile station returns 320 to the automatic answer state 302 awaiting future incoming session invitations.

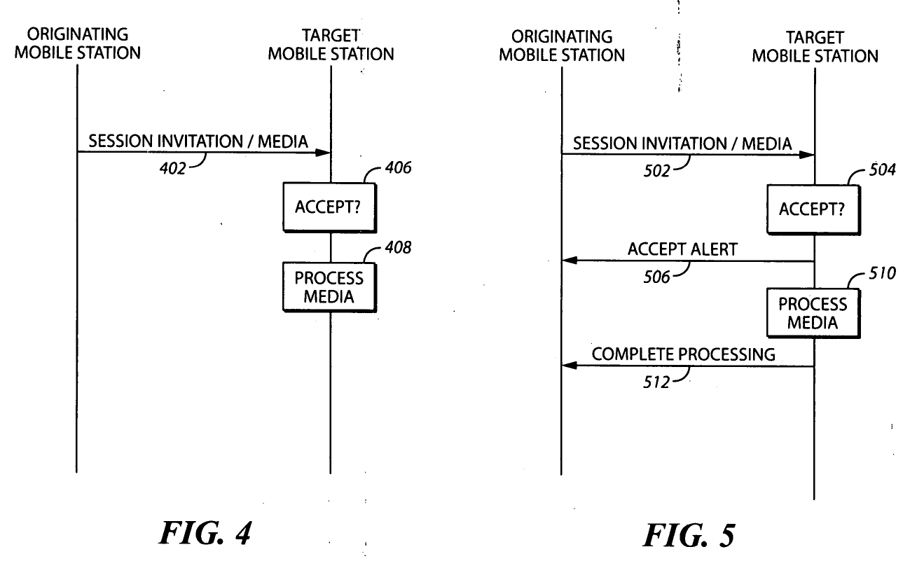

Referring now to FIG. 4, one example of a polite communication exchange between an originating mobile station and a target mobile station is described. At step 402, a session invitation message is formed and sent from the originating mobile station to the target mobile station. The session invitation requests that a user at the target mobile station manually accept the session invitation thereby, at least temporarily, overriding the automatic answer mode in which the target mobile station is currently operating. Media is also included with the session invitation message. In one example, a recorded audio message is sent with the session invitation message. In another example, a video image is sent with the session invitation message. Other examples of media are possible.

At step 406, the user at the target mobile station determines whether to accept the session invitation. At step 408, the media is processed depending upon whether the session invitation has been accepted or rejected. This processing may include rendering the media to the user at the target mobile station if an acceptance has been made. On the other hand, if a rejection has been made, the media may be saved in a memory or discarded. Other processing actions are possible.

Referring now to FIG. 5, another example of a polite communication exchange between an originating mobile station and a target mobile station is described. At step 502, a session invitation message is formed and sent from the originating mobile station to the target mobile station. The session invitation requests that a user at the target mobile station manually accept the session invitation thereby, at least temporarily, overriding the automatic answer mode in which the target mobile station is currently operating. Media is also included with the session invitation message. In one example, a recorded audio message is sent with the session invitation message. In another example, a video image is sent with the session invitation message. Other examples of media are possible.

At step 504, the user at the target mobile station determines whether to accept the session invitation. If an acceptance is made, at step 506 an acceptance alert is sent to the user at the originating mobile station. At step 508, the media is processed depending upon whether the session invitation has been accepted or rejected. This processing may include rendering the media to the user at the target mobile station if an acceptance has been made. On the other hand, if a rejection had been made, the media may be saved in memory or discarded. Other actions are possible. At step 512, the target mobile station sends the originating mobile station a message that indicates the processing of the message has been completed. In one example, this message indicates that an audio message has been played to the user at the target mobile station.

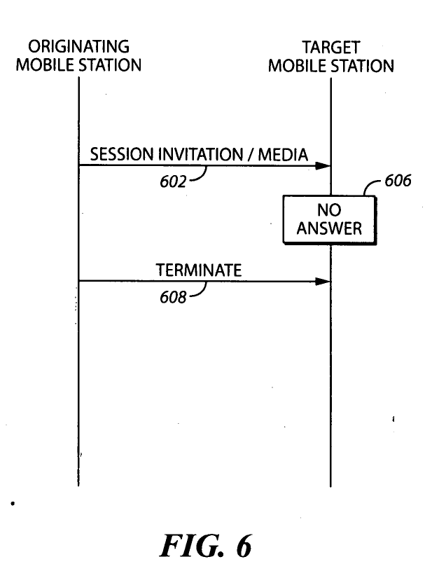

Referring now to FIG. 6, still another example of a polite communication exchange between an originating mobile station and a target mobile station is described. At step 602, a session invitation message is formed and sent from the originating mobile station to the target mobile station. The session invitation requests that a user at the target mobile station manually accept the session invitation thereby, at least temporarily, overriding an automatic answer mode in which the target mobile station is currently operating. Media is also included with the session invitation message. In one example, a recorded audio message is sent with the session invitation message. In another example, a video image is sent with the session invitation message. Other examples of media are possible.

At step 606, no answer to the session invitation is made by the user at the target mobile station. At step 608, since the originating mobile station has not received an indication that the session invitation has been accepted, a terminate message is sent from the originating mobile station to the target mobile station. Once the termination message is received by the target mobile station, the target mobile station may take some action with any media that it still possesses, such as discarding the media.

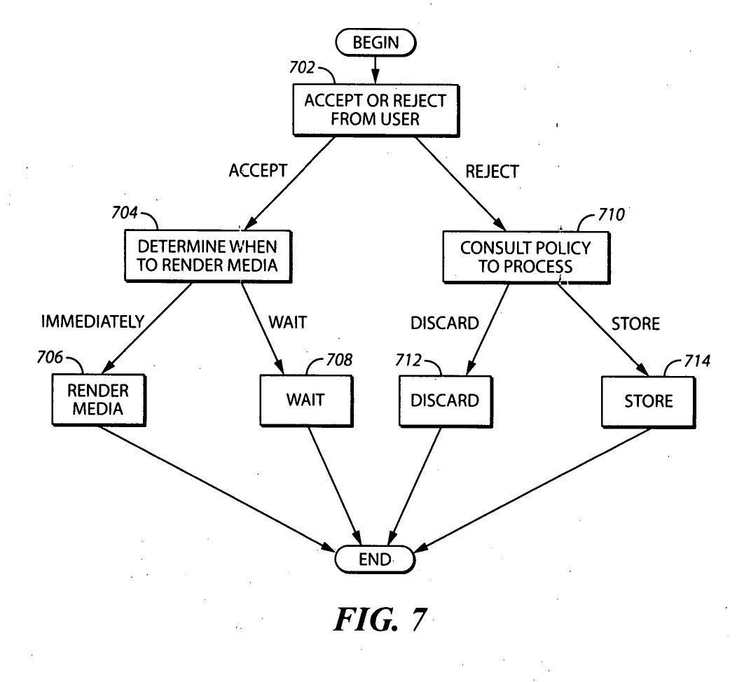

Referring now to FIG. 7, one example of an approach to determine a processing action for media received at a target mobile station is described. At step 702, an accept or reject indication for a session invitation is received from the user at the target mobile station.

If an accept indication is received, at step 704, it is determined when to render media to the user at the target mobile station. If the decision is made to render the media to the user substantially immediately, then at step 706, the media may be rendered substantially immediately to the user. As previously mentioned, the determination as to whether to render the media substantially immediately may not be automatic and may be further based upon a number of factors, for example, whether the target mobile station is using a speaker phone, whether the target mobile station is using a headset, the current present state of the target mobile station, or whether the target mobile station is positioned in playback venue where more than a predetermined percentage of calls are using a speaker phone.

On the other hand, if it is determined not to render the media substantially immediately, then at step 708 the mobile station waits to render the media. This waiting may occur for a fixed amount of time or for a variable amount of time and may be based upon a policy or an evaluation of conditions at the target mobile station. It will be understood that other options for processing the message are possible.

If a rejection indication is received from the user at the target mobile station at step 702, then at 710, a policy at the target mobile station may be consulted to determine what to do with the media. For instance, the policy may indicate that all high-priority messages are to be stored at the target mobile station for later use. In another example, the policy may indicate that low-priority messages are to be discarded by the target mobile station. If the decision is to discard the message, then at step 712, the message is discarded. On the other hand, if the decision is to store the message, then at step 714, the message is stored for later use. It will be understood that other options for processing the message are possible.

Thus, polite communications are exchanged between users in a quick and efficient manner. Performance delays are reduced as are the number of required user interactions with mobile stations. Moreover, the present approaches maintain and enhance the speedy communications supported by many current communication networks such as PTT systems.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of politely initiating a communication session comprising:
operating a target mobile station in an automatic answer mode;
receiving at least one session invitation at the target mobile station, the session invitation requesting that a user manually accept the session invitation thereby, at least temporarily, overriding the automatic answer mode; and
determining whether to manually accept the at least one session invitation.

2. The method of claim 1 wherein receiving the at least one session invitation comprises receiving an automatic answer override message.

3. The method of claim 1 further comprising receiving media in addition to the at least one session invitation.

4. The method of claim 3 wherein receiving media comprises receiving an audio message.

5. The method of claim 3 wherein the media is only rendered when a user manually accepts the at least one session invitation.

6. The method of claim 3 further comprising sending an alert when the target mobile station completes rendering the media delivered with the at least one session invitation.

7. The method of claim 3 further comprising, when the determining results in the user at the target mobile station manually accepting the at least one session invitation, rendering the media to the user substantially immediately after the user at the target mobile station accepts.

8. The method of claim 3 further comprising, when the determining results in the user at the target mobile station not manually accepting the at least one session invitation, storing the media in a memory for potential later use.

9. The method of claim 3 further comprising, when the determining results in the user at the target mobile station not manually accepting the at least one session invitation, discarding the media.

10. The method of claim 3 further comprising, when the determining results in the user at the target mobile station manually accepting the at least one session invitation, determining whether to render the media substantially immediately based upon a condition, the condition selected from a group comprising: whether the target mobile station is using a speaker phone; whether the target mobile station is using a headset; a value of a current present state of the target mobile station; and, whether the target mobile station is positioned in playback venue where more than a predetermined percentage of calls use a speaker phone.

11. The method of claim 3 further comprising sending the media to the target mobile station with a lower Quality of Service (QoS) until the at least one session invitation is manually accepted.

12. The method of claim 4 further comprising sending the media to the target mobile station with a higher Quality of Service (QoS) after the at least one session invitation is manually accepted.

13. The method of claim 1 further comprising informing an originating user that the target mobile station does not accept the at least one session invitation.

14. A method of politely initiating a communication session comprising:
forming at least one session invitation requesting that a user at a target mobile station operating in an automatic answer mode manually accept the session invitation; and
sending the at least one session invitation to the target mobile station.

15. The method of claim 14 further comprising recording media, and transmitting the media along with the at least one session invitation to the target mobile station.

16. The method of claim 15 further comprising querying the target mobile station to determine whether the media can be rendered immediately.

17. A mobile station comprising:
a receiver having a input;
an input apparatus; and
a controller coupled to the receiver and the input apparatus, the controller programmed to receive at least one session invitation at the input of the receiver, the at least one session invitation requesting that a user at the mobile station manually accept the session invitation thereby, at least temporarily, overriding an automatic answer mode of the mobile station, the controller further programmed to determine whether to accept the at least one session invitation based at least in part upon user input received at the input apparatus.

18. The mobile station of claim 17 wherein the receiver additionally receives media with the at least one session invitation.

19. The mobile station of claim 18 wherein the controller is further programmed to render the media to the user substantially immediately after the user accepts.

20. The mobile station of claim 18 wherein the controller is further programmed to take an action selected from a group comprising: store at least a portion of the media and discard the media.
